(19) United States
(12) Patent Application Publication
(10) Pub. No.: US 2022/0308908 A1
(43) Pub. Date: Sep. 29, 2022

(54) SYSTEM AND METHOD TO MAINTAIN QUALITY OF SERVICE ASSOCIATED WITH CLOUD APPLICATION

(71) Applicant: VMware, Inc., Palo Alto, CA (US)

(72) Inventors: Wei ZHENG, Shanghai (CN); Jin FENG, Shanghai (CN); Chengmao LU, Shanghai (CN); Wenguang WANG, Santa Clara, CA (US); Yang YANG, Shanghai (CN); Yang YANG, Shanghai (CN)

(73) Assignee: VMware, Inc., Palo Alto, CA (US)

(21) Appl. No.: 17/214,976

(22) Filed: Mar. 29, 2021

(51) Int. Cl. G06F 9/455

(52) U.S. Cl. CPC G06F 9/45558; G06F 2009/45595; G06F 2009/4557

(57) ABSTRACT

Example methods relating to maintain a quality of service of a cloud application are described. One example method includes monitoring a workload metric of a virtual machines which is running the cloud application, creating additional one or more virtual machines, isolating the additional one or more virtual machines, and determining whether the workload metric exceeds a threshold. In response to determining that the workload metric exceeds the threshold, the method includes deisolating the additional one or more virtual machines to support the cloud application. Otherwise, the method includes maintaining one or more virtual machines being isolated.

### BACKGROUND

Unless otherwise indicated herein, the approaches described in this section are not admitted to be prior art by inclusion in this section.

Cloud applications may run on multiple virtualized computing instances in a cloud virtualized computing environment. Some cloud applications may run on multiple containers and other cloud application may run on virtual machines. A scaling out of a cloud application is one common technology to increase a workload handling capability associated with the cloud application to maintain a quality of service of the application. The cloud applications run on containers may be quickly scaled out because of modern container technologies. However, scaling out cloud applications run on virtual machines is much slower. Therefore, in response to scaling out the cloud applications run on virtual machines, it has been a challenge to maintain the quality of service associated with these cloud applications.

### BRIEF DESCRIPTION OF DRAWINGS

FIG. 1 is a schematic diagram illustrating an example virtualized computing environment to perform an automatic scaling to support one or more cloud applications;

FIG. 2 illustrates an example text document defining all commands to automatically create a virtual machine for a specific cloud application;

FIG. 3 illustrates an example pipeline application; and

FIG. 4 is a flowchart of example process for a management entity to perform an automatic scaling to support one or more cloud applications in a virtualized computing environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

In the following detailed description, the term “cloud application” broadly refers to a software program that is run and deployed in a cloud environment, such as a private cloud, a public cloud, a hybrid cloud or a combination thereof. The term “isolation” of a virtual machine broadly refers to limiting any traffic external to the virtual machine from interfering with the operations of the virtual machine. The term “deisolation” or “deisolating” refers to remove a virtual machine from “isolation.”

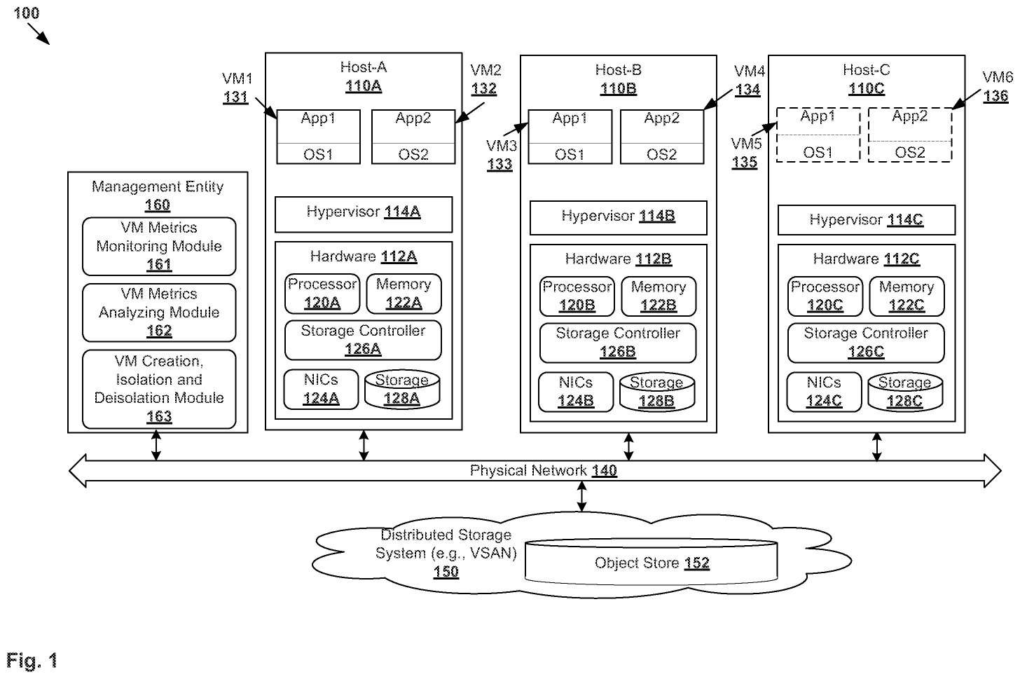

Challenges relating to perform an automatic scaling to support one or more cloud applications in a virtualized computing environment will now be explained in more details using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes multiple hosts, such as Host-A 110A, Host-B 110B and Host-C 110C. In the following, reference numerals with a suffix “A” relates to Host-A 110A, suffix “B” relates to Host-B 110B, and suffix “C” relates to Host-C 110C. Although three hosts (also known as “host computers”, “physical servers”, “server systems”, “host computing systems”, etc.) are shown for simplicity, virtualized computing environment 100 may include any number of hosts.

Each host 110A/110B/110C in includes suitable hardware 112A/112B/112C and executes virtualization software such as hypervisor 114A/114B/114C to maintain a mapping between physical resources and virtual resources assigned to various virtual machines. For example, Host-A 110A supports VM1 131 and VM2 132; Host-B 110B supports VM3 133 and VM4 134; and Host-C 110C supports VM5 135 and VM6 136. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/110B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A-110C may aggregate their storage resources 128A-128C to form distributed storage system 150, which represents a shared pool of storage resources. For example, in FIG. 1, Host-A 110A, Host-B 110B and Host-C 110C aggregate respective local physical storage resources 128A, 128B and 128C into object store 152 (also known as a datastore or a collection of datastores). In this case, data (e.g., virtual machine data) stored on object store 152 may be placed on, and accessed from, one or more of storage resources 128A-128C. In practice, distributed storage system 150 may employ any suitable technology, such as Virtual Storage Area Network (vSAN) from VMware, Inc.

In virtualized computing environment 100, management entity 160 provides management functionalities to various managed objects, such as hosts 110A-110C, virtual machines 131-136, etc. Management entity 160 may include VM metrics monitoring module 161, which is configured to collect workload metrics of virtual machines 131-136. Management entity 160 may further include VM metrics analyzing module 162, which is configured to aggregate and analyze workload of virtual machines 131-136. Management entity 160 may further include VM creation, isolation and deisolation module 163 to deploy virtual machines for running one or more cloud applications, to isolate deployed virtual machines and to deisolate the isolated virtual machines. Management entity 160 may be implemented using physical machine(s), virtual machine(s), or both.

Automatic scaling is a technique to adjust a performance of a cloud application based on actual workloads associated with the cloud application. For some cloud applications run on virtual machines, in response to a peak actual workload associated with the cloud application, conventional automatic scaling then provisions virtual machines, installing, configuring and testing the cloud application on the virtual machines and deploying the virtual machines in virtualized computing environment 100 to support the cloud application. Therefore, conventional automatic scaling usually takes tens of minutes to complete which is not preferred or becomes an obstacle to maintain a quality of service associated with such cloud applications.

In some embodiments, VM1 131 and VM3 133 are configured to run a first cloud application (i.e., App1). The App1 can only be run on a first guest operating system (i.e., OS1). Therefore, VM1 131 and VM3 133 both install OS1 to run App1 on OS1. Similarly, VM2 132 and VM4 134 are configured to run a second cloud application (i.e., App2). The App2 can only be run on a second guest operating system (i.e., OS2). Therefore, VM2 132 and VM4 134 both install OS2 to run App2 on OS2.

In some embodiments, VM metrics monitoring module 161 is configured to collect actual workload metrics of each virtual machine (i.e., VM1 131, VM2 132, VM3 133 and VM4 134) in virtualized computing environment 100 on which a cloud application (i.e., App1 or App2) is running. In some embodiments, the workload metrics include, but not limited to, virtual CPU workload metric and virtual memory workload metric of a virtual machine. Example workload metrics collected by VM metrics monitoring module 161 may be shown in Table 1 below.

TABLE 1

| | | | | |
|---|---|---|---|---|
| VM1 ID | App1 ID | Timestamp1 | CPU1 metric | Memory1 metric |
| VM2 ID | App2 ID | Timestamp2 | CPU2 metric | Memory2 metric |
| VM3 ID | App1 ID | Timestamp3 | CPU3 metric | Memory3 metric |
| VM4 ID | App2 ID | Timestamp4 | CPU4 metric | Memory4 metric |

In a first row of Table 1, VM1 ID refers to an identification code of VM1 131, App1 ID refers to an identification code of App1 running on VM1 131, CPU1 metric refers to a processing workload metric of a virtual CPU of VM1 131 and Memoryl metric refers to a memory workload metric of a virtual memory of VM1 131. Timestamp1 refers to a time point at which CPU1 metric and Memory1 metric are collected from VM1 131 by VM metrics monitoring module 161.

Similarly, in a second row of Table 1, VM2 ID refers to an identification code of VM2 132, App2 ID refers to an identification code of App2 running on VM2 132, CPU2 metric refers to a processing workload metric of a virtual CPU of VM2 132 and Memory2 metric refers to a memory workload metric of a virtual memory of VM2 132. Timestamp2 refers to a time point at which CPU2 metric and Memory2 metric are collected from VM2 132 by VM metrics monitoring module 161.

In a third row of Table 1, VM3 ID refers to an identification code of VM3 133, App1 ID refers to an identification code of App1 running on VM3 133, CPU3 metric refers to a processing workload metric of a virtual CPU of VM3 133 and Memory3 metric refers to a memory workload metric of a virtual memory of VM3 133. Timestamp3 refers to a time point at which CPU3 metric and Memory3 metric are collected from VM3 133 by VM metrics monitoring module 161.

In a fourth row of Table 1, VM4 ID refers to an identification code of VM4 134, App2 ID refers to an identification code of App2 running on VM4 134, CPU4 metric refers to a processing workload metric of a virtual CPU of VM4 134 and Memory4 metric refers to a memory workload metric of a virtual memory of VM4 134. Timestamp4 refers to a time point at which CPU4 metric and Memory4 metric are collected from VM4 134 by VM metrics monitoring module 161.

In some embodiments, VM metrics monitoring module 161 is configured to continuously collect actual workload metrics of each virtual machine on which a cloud application is running as discussed above. In some embodiments, VM metrics analyzing module 162 is configured to aggregate and analyze the workload metrics collected for a period of time (e.g., on a weekly basis).

In some embodiments, with the aggregated weekly workload metrics, VM metrics analyzing module 162 is configured to identify a number of virtual machines being used in the past week to support App1 and App2 in different time periods based on timestamps (e.g., Timestamp1, Timestamp2, Timestamp3 and Timestamp4). Therefore, VM metrics analyzing module 162 is configured to predict a number of virtual machines to be deployed for supporting App1 and App2 in different time periods. In some other embodiments, VM metrics analyzing module 162 may include one or more artificial intelligent engine to predict the number of virtual machines to be deployed for supporting App1 and App2 in different time periods. Such prediction may be achieved by, not limited to, deep learning, machine learning and etc.

For illustration only, in response to VM metrics analyzing module 162 identifying that App1 was supported by a maximum number of virtual machines at 12 P.M. last Friday in the last week, VM metrics analyzing module 162 is configured to predict that the same maximum number of virtual machines or more virtual machines need to be deployed to support App1 before 12 P.M. this Friday. Therefore, in addition to virtual machines on which App1 is running, VM creation, isolation and deisolation module 163 is configured to create additional virtual machines (e.g., VM5 135) for running App1 before 12 P.M. this Friday. The number of the additional virtual machines may be a difference between the maximum number of virtual machines and the number of virtual machines on which App1 is running.

In some embodiments, the creation of VM5 135 may include identify available resources capable of supporting a base virtual machine, download a template of an image of the base virtual machine, provision a virtual machine from the template, install OS1 on the provisioned virtual machine, install, configure and test App1 on the provisioned virtual machine. In response to the completion of the creation, VM creation, isolation and deisolation module 163 is then configured to isolate VM5 135.

In some embodiments, VM creation, isolation and deisolation module 163 may take various approaches to isolate VM5 135. For example, VM creation, isolation and deisolation module 163 may suspend VM 5 135 and persist all information associated with suspended VM5 135 in object store 152. In some alternative embodiments, VM creation, isolation and deisolation module 163 may apply a network isolation strategy to VM 5 135 to isolate VM5 135 from traffic external to VM5 135. Some example network isolation strategy may include, but not limited to, isolation by subnetwork or security group. Isolation by subnetwork may involve creating a new subnetwork during deployment and attaching VM5 135 to the new subnetwork. Isolation by security group involves creating a new security group with rules or policies to allow communication only between VM5 135 and other virtual machines that must be isolated and attaching the VM5 135 to an existing network. In yet alternative embodiments, VM creation, isolation and deisolation module 163 may hide an address associated with VM5 135 from being exposed in virtualized computing environment 100.

In some embodiments, the creations and isolations of VM5 135 and other additional virtual machines for running App1 are completed before 12 P.M. this Friday.

For illustration only, in response to VM metrics analyzing module 162 identifying that App2 was supported by a maximum number of virtual machines at 9 A.M. last Monday in the last week, VM metrics analyzing module 162 is configured to predict that the same maximum number of virtual machines or more virtual machines need to be deployed to support App2 before 9 A.M. this Monday.

In some embodiments, in addition to virtual machines on which App2 is running, VM creation, isolation and deisolation module 163 is configured to create additional virtual machines (e.g., VM6 136) for running App2 before 9 A.M. this Monday. The number of the additional virtual machines may be a difference between the maximum number of virtual machines and the number of virtual machines on which App2 is running.

In some embodiments, the creation of VM6 136 may include identify available resources capable of supporting a base virtual machine, download a template of an image of the base virtual machine, provision a virtual machine from the template, install OS2 on the provisioned virtual machine, install, configure and test App2 on the provisioned virtual machine. In response to the completion of the creation, VM creation, isolation and deisolation module 163 is then configured to isolate VM6 136.

In some embodiments, VM creation, isolation and deisolation module 163 may take various approaches to isolate VM6 136. For example, VM creation, isolation and deisolation module 163 may suspend VM6 136 and persist all information associated with suspended VM6 136 in object store 152. In some alternative embodiments, VM creation, isolation and deisolation module 163 may apply a network isolation strategy to VM6 136 to isolate VM6 136 from traffic external to VM6 136. Some example network isolation strategy may include, but not limited to, isolation by subnetwork or security group. Isolation by subnetwork may involve creating a new subnetwork during deployment and attaching VM6 136 to the new subnetwork. Isolation by security group involves creating a new security group with rules or policies to allow communication only between VM6 136 and other virtual machines that must be isolated and attaching the VM6 136 to an existing network. In yet alternative embodiments, VM creation, isolation and deisolation module 163 may hide an address associated with VM6 136 from being exposed in virtualized computing environment 100.

The creations and isolations of VM6 136 and other additional virtual machines to support App2 are completed before 9 A.M. this Monday.

In some embodiments, in response to VM metrics analyzing module 162 determining a workload metric associated with a running virtual machine to support App1 exceeds a predetermined threshold, VM creation, isolation and deisolation module 163 is configured to deisolate isolated VM5 135 to support App1. On the other hand, in response to VM metrics analyzing module 162 determining a workload metric associated with a running virtual machine to support App2 exceeds a predetermined threshold, VM creation, isolation and deisolation module 163 is configured to deisolate isolated VM6 136 to support App2. Therefore, a quality of service associated with cloud applications App1 and App2 can be maintained.

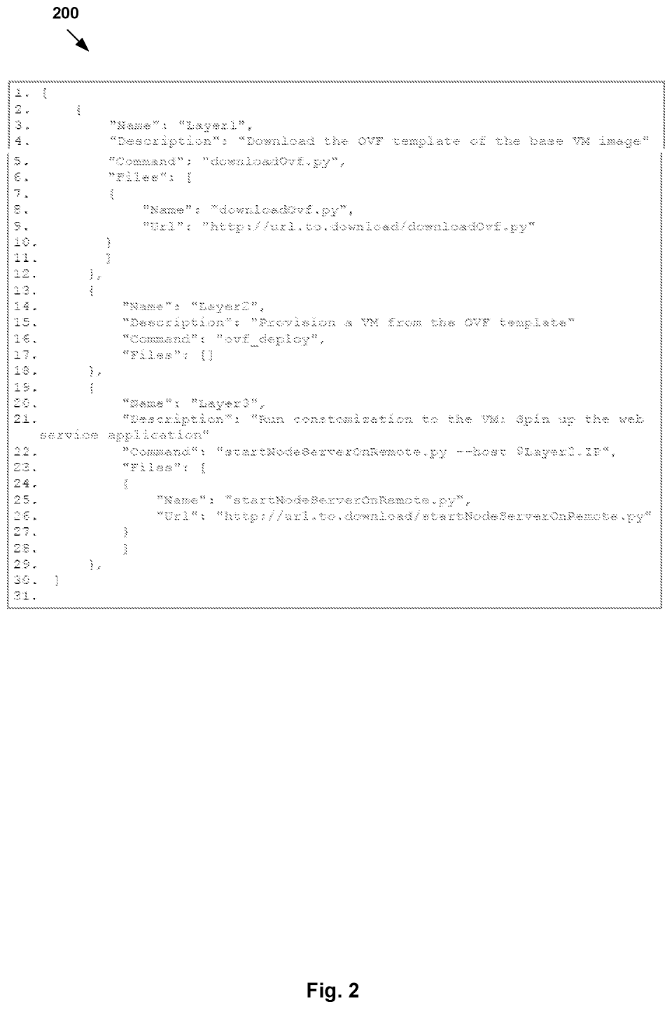

FIG. 2 illustrates a text document 200 defining all commands to automatically create a virtual machine for a specific cloud application. In conjunction with FIG. 1, the specific cloud application may be App1 or App2. Based on text document 200, a virtual machine provision for a specific cloud application may be abstracted into an executable specification to automatically provision the virtual machine for the specific cloud application when needed (e.g., a workload metric associated with a running virtual machine to support the specific cloud application exceeding a predetermined threshold) without use's interference.

Text document 200 may include layers. In some embodiments, for illustration only, text document 200 include three layers. The three layers include, but not limited to, Layer 1 from Line 2 to Line 12 in text document 200, Layer 2 from Line 13 to Line 18 in text document 200 and Layer 3 from Line 19 to Line 29 in text document 200. Any layer may execute things that are executable in command lines, such as a built-in virtual machine provision command, a binary executable or a self-written script that applies configurations to the virtual machine. In some embodiments, text document 200 may include additional layers associated with updating operating system, applying security patches and installing latest application releases, etc.

In some embodiments, Layer 1 refers to downloading a template of an image of a base virtual machine, Layer 2 refers to provisioning a virtual machine from the template and Layer 3 refers to customizing the provisioned virtual machine for the specific cloud application, including, but not limited to, installing a guest operating system on the provisioned virtual machine, and installing, configuring and testing the cloud application on the provisioned virtual machine.

In some embodiments, Layer 1, Layer 2 and Layer 3 are executed in sequence. In response to the executions of each layer, a plurality of resources (e.g., script files, software binaries) are called for the executions of each layer. For example, in conjunction with FIG. 1, VM creation, isolation and deisolation module 163 may dynamically select host-C 110C and send a command to host-C 110C so that host-C 110C performs executions illustrated in text document 200.

In some embodiments, in response to a failure during the executions, host-C 110C may send an error message to VM creation, isolation and deisolation module 163 so that VM creation, isolation and deisolation module 163 is aware that host-C 110C cannot execute text document 200 and may send another command to other hosts in virtualized computing environment 100 to perform executions illustrated in text document 200.

In some embodiments, in response to the executions being success, host-C 110C may create VM5 135 for App1 or VM6 136 for App2 and notifies VM creation, isolation and deisolation module 163. VM creation, isolation and deisolation module 163 is then configured to isolate VM5 135 or VM6 136.

In some embodiments, it worth notes that text document 200 is for a specific cloud application. Therefore, App1 may correspond to a first text document (e.g., text document 200) and App2 may correspond to a different second text document (e.g., another text document other than text document 200). In addition, it also worth notes that virtual machines for a specific cloud application are created from the same text document. Therefore, the virtual machines for the specific cloud application are allocated with the same virtual resources and have the same configurations.

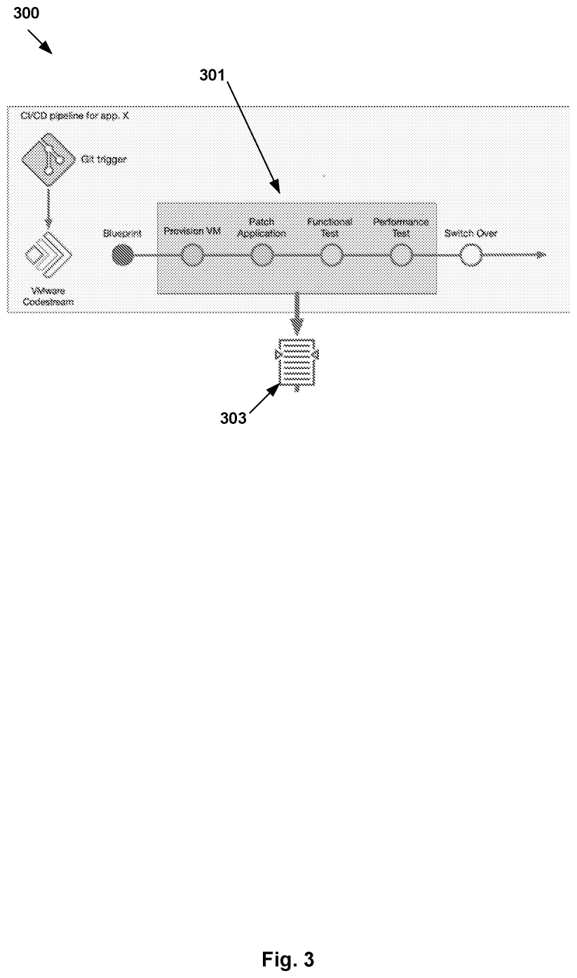

FIG. 3 illustrates an example pipeline application 300. Pipeline application 300 includes pipeline 301 and text document 303. Pipeline 301 is a continuous integration and continuous deliver (CI/CD) pipeline that enables frequent deployment of one or more cloud applications. In some embodiments, text document 303 may correspond to text document 200 discussed above.

Pipeline 301 can be thought of as a multi-stage linear process, with main stages of blueprint, provision VM, patch application, functional test, performance test and switch over, each comprising various substages and tasks. In some embodiments, text document 303 includes commands to be executed in a serial sequence. Therefore, text document 303 may be easily integrated into pipeline 301 to replace stages of provision VM and patch application. Accordingly, automatically creating one or more virtual machines for a specific cloud application can easily leverage efforts having been used in building the CI/CD pipeline 301.

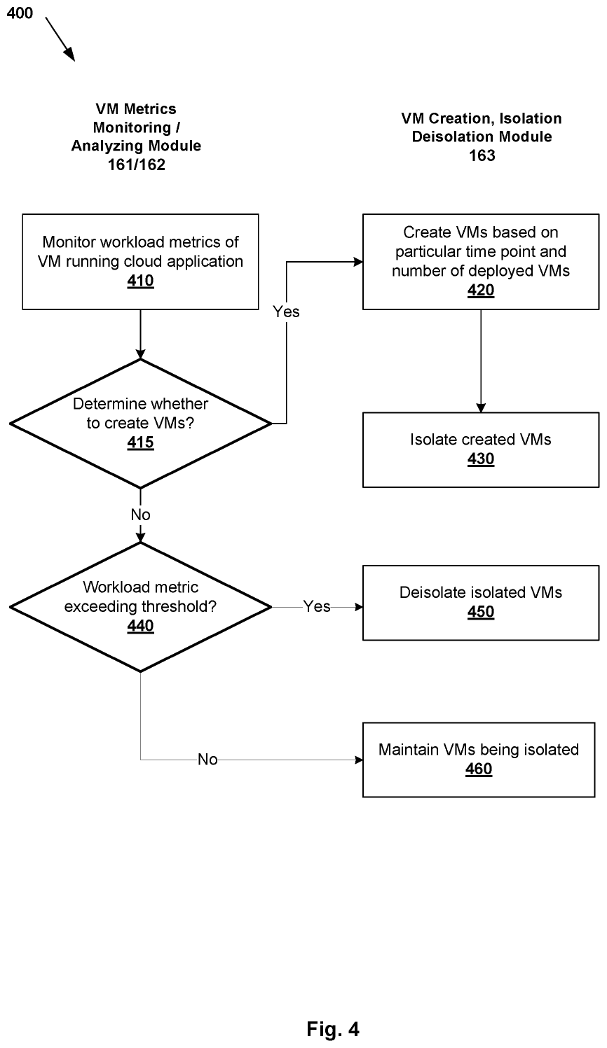

FIG. 4 is a flowchart of example process 400 for a management entity to perform an automatic scaling to support one or more cloud applications in a virtualized computing environment. Example process 400 may include one or more operations, functions, or actions illustrated by one or more blocks, such as 410 to 460. The various blocks may be combined into fewer blocks, divided into additional blocks, and/or eliminated depending on the desired implementation.

In some embodiments, in conjunction with FIG. 1, VM metrics monitoring module 161 is configured to monitor workload metrics of each virtual machine on which a cloud application is running. For example, VM metrics monitoring module 161 is configured to collect actual workload metrics of VM1 131 and VM3 133 both running App1 and VM2 132 and VM4 134 both running App2. Block 410 may be followed by block 415.

In block 415, VM metrics analyzing module 162 is configured to determine whether to create one or more virtual machines to run one or more cloud applications. In some embodiments, VM metrics analyzing module 162 is configured to analyze workload metrics collected for a period of time of VM1 131 and VM3 133 both running App1 and VM2 132 and VM4 134 both running App2 to determine whether to create a number of virtual machines to run App1 or App2 at a particular time point based on a particular number of deployed virtual machines.

In some embodiments, the particular time point may refer to a time point at which a workload metric of a virtual machine running a cloud application is collected by VM metrics monitoring module 161. The particular number of deployed virtual machines may refer to a number of virtual machines having been deployed to support a cloud application. The number may be the maximum number of virtual machines having been deployed to support the cloud application in a time period monitored by VM metrics monitoring module 161.

For example, VM metrics monitoring module 161 has monitored workload metrics of each running virtual machine on which a cloud application (e.g., App1) is running for a period of time (e.g., a year). Based on identification codes of virtual machines and timestamps included in the monitored workload metrics for the period of time, VM metrics analyzing 162 is configured to identify the number of virtual machines having been deployed to support the cloud application at different timestamps.

For illustration only, assuming VM metrics analyzing module 162 identifying that App1 was supported by a maximum number of virtual machines (e.g., 100 virtual machines) during the New Year holidays in the past year, VM metrics analyzing module 162 is configured to predict that 100 virtual machines need to be deployed before the New Year holidays this year. Block 415 may be followed by block 420.

Therefore, in block 420, in addition to running virtual machines which are supporting App1, VM creation, isolation and deisolation module 163 is configured to create (100 — number of running virtual machines which are supporting App1) virtual machines before the New Year holidays this year. In some embodiments, VM creation, isolation and deisolation module 163 is configured to allocate sufficient resources to create (100 — number of running virtual machines which are supporting App1) virtual machines. The allocation may include, but not limited to, incorporating additional physical or virtual resources into virtualized computing environment 100 or freeing up occupied physical or virtual resources in virtualized computing environment 100. Block 420 may be followed by block 430.

In block 430, VM metrics monitoring and deploying service 162 is configured to isolate the created (100 — number of running virtual machines which are supporting App1) virtual machines.

In some other embodiments, in response to determining no additional virtual machines are created, block 415 may be also followed by block 440. In block 440, VM metrics analyzing module 162 is configured to determine whether a workload metric of any running virtual machines which are supporting App1 exceeds a threshold. Some example threshold may be associated with, but not limited to, a virtual CPU workload threshold, a virtual memory workload threshold, an averaged ingress traffic volume threshold of a VM, an averaged input/output read/write threshold of a VM. In response to VM metrics analyzing module 162 determining none of workload metric of any running virtual machines which are supporting App1 exceeds a threshold, block 440 may be followed by block 460.

In block 460, virtual machines isolated in block 430 maintain being isolated.

In response to VM metrics analyzing module 162 determining a workload metric of any running virtual machines which are supporting App1 exceeds a threshold, block 440 may be followed by block 450.

In block 450, VM creation, isolation and deisolation module 163 is configured to deisolate a part of or all virtual machines isolated in block 430 to support App1. Therefore, a quality of service associated with App1 may be maintained.

In some embodiments, VM creation, isolation and deisolation module 163 may take various approaches to deisolate a part of or all virtual machines isolated in block 430. For example, VM creation, isolation and deisolation module 163 may resume at least one isolated virtual machine by reading all information associated with the isolated virtual machine from object store 152. Alternatively, VM creation, isolation and deisolation module 163 may deactivate a network isolation strategy applied to at least one isolated virtual machine so that the virtual machine will not be isolated anymore by the network isolation strategy. Moreover, VM creation, isolation and deisolation module 163 may expose or reveal an address associated with at least one isolated virtual machine in virtualized computing environment 100.

In some embodiments, blocks 410 to 460 may be iterated. In these embodiments, given there are already virtual machines being isolated, in block 420, VM creation, isolation and deisolation module 163 is configured to create (100 — number of running virtual machines which are supporting App1 — number of isolated virtual machines) virtual machines before the New Year holidays this year. In response to the number of running virtual machines which are supporting App1 and the number of isolated virtual machines equals to or are greater than 100, VM creation, isolation and deisolation module 163 is configured to create zero virtual machine.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

It will be understood that although the terms “first,” “second,” “third” and so forth are used herein to describe various elements, these elements should not be limited by these terms. These terms are only used to distinguish one element from another. For example, within the scope of the present disclosure, a first element may be referred to as a second element, and similarly a second element may be referred to as a first element. As used herein, the term “and/or” includes any and all combinations of one or more of the associated listed items.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a management entity to maintain a quality of service of a cloud application in a virtualized computing environment, wherein the method comprises:
monitoring a workload metric of a virtual machine which is running the cloud application;
creating additional one or more virtual machines based on a particular time point and a particular number of virtual machines deployed to run the cloud application;
isolating the additional one or more virtual machines;
determining whether the workload metric exceeds a threshold;
in response to determining that the workload metric exceeds the threshold:
deisolating the additional one or more virtual machines to support the cloud application; and
in response to determining that the workload metric does not exceed the threshold: maintaining one or more virtual machines being isolated.

2. The method of claim 1, wherein the creating and isolating are performed before a time point corresponding to the particular time point.

3. The method of claim 1, wherein the creating additional one or more virtual machines is based on a same document including all commands to automatic create the additional one or more virtual machines.

4. The method of claim 3, wherein the document defines that the commands are executed in a serial sequence.

5. The method of claim 1, wherein the creating additional one or more virtual machines further includes downloading a template of an image of a base virtual machine and provisioning the additional one or more virtual machines from the template.

6. The method of claim 1, wherein the creating additional one or more virtual machines further includes installing, configuring and testing a guest operating system and the cloud application on all of the additional one or more virtual machines.

7. The method of claim 1, wherein the creating additional one or more virtual machines is based on the particular number of virtual machines deployed to run the cloud application and a number of virtual machines which are running the cloud application.

8. The method of claim 7, in response to maintaining the one or more virtual machines being isolated, wherein the creating additional one or more virtual machines is also based on a number of the one or more virtual machines being isolated.

9. A non-transitory computer-readable storage medium, containing a set of instructions which, in response to execution by a processor, cause the processor to perform a method for a management entity to maintain a quality of service of a cloud application in a virtualized computing environment, the method comprising:
monitoring a workload metric of a virtual machines which is running the cloud application;
creating additional one or more virtual machines based on a particular time point and a particular number of virtual machines deployed to run the cloud application;
isolating the additional one or more virtual machines;
determining whether the workload metric exceeds a threshold;
in response to determining that the workload metric exceeds the threshold:
deisolating the additional one or more virtual machines to support the cloud application; and
in response to determining that the workload metric does not exceed the threshold: maintaining one or more virtual machines being isolated.

10. The non-transitory computer-readable storage medium of claim 9, wherein the creating and isolating are performed before a time point corresponding to the particular time point.

11. The non-transitory computer-readable storage medium of claim 9, wherein the creating additional one or more virtual machines is based on a same document including all commands to automatic create the additional one or more virtual machines.

12. The non-transitory computer-readable storage medium of claim 11, wherein the document defines that the commands are executed in a serial sequence.

13. The non-transitory computer-readable storage medium of claim 9, wherein the creating additional one or more virtual machines further includes downloading a template of an image of a base virtual machine and provisioning the additional one or more virtual machines from the template.

14. The non-transitory computer-readable storage medium of claim 9, wherein the creating additional one or more virtual machines further includes installing, configuring and testing a guest operating system and the cloud application on all of the additional one or more virtual machines.

15. The non-transitory computer-readable storage medium of claim 9, wherein the creating additional one or more virtual machines is based on the particular number of virtual machines deployed to run the cloud application and a number of virtual machines which are running the cloud application.

16. The non-transitory computer-readable storage medium of claim 15, in response to maintaining the one or more virtual machines being suspended, wherein the creating additional one or more virtual machines is also based on a number of the one or more virtual machines being isolated.

17. A management entity to maintain a quality of service of a cloud application in a virtualized computing environment, wherein the management entity includes: a processor; and
a non-transitory computer-readable medium having stored thereon instructions that, in response to execution by the processor, cause the processor to:
monitor a workload metric of a virtual machines which is running the cloud application;
create additional one or more virtual machines based on a particular time point and a particular number of virtual machines deployed to run the cloud application;
isolate the additional one or more virtual machines;
determine whether the workload metric exceeds a threshold;
in response to determining that the workload metric exceeds the threshold:
deisolate the additional one or more virtual machines to support the cloud application; and
in response to determining that the workload metric does not exceed the threshold: maintain one or more virtual machines being isolated.

18. The management entity of claim 17, wherein the non-transitory computer- readable medium having stored thereon additional instructions that, in response to execution by the processor, cause the processor to create and isolate before a time point corresponding to the particular time point.

19. The management entity of claim 17, wherein the non-transitory computer- readable medium having stored thereon additional instructions that, in response to execution by the processor, cause the processor to create additional one or more virtual machines based on a same document including all commands to be executed in a serial sequence to automatic create the additional one or more virtual machines.

20. The management entity of claim 17, wherein the non-transitory computer- readable medium having stored thereon additional instructions that, in response to execution by the processor, cause the processor to create additional one or more virtual machines based on the particular number of virtual machines deployed to run the cloud application, a number of virtual machines which are running the cloud application and a number of the one or more virtual machines being isolated in response to maintaining the one or more virtual machines being isolated.
